(19) United States
(12) Patent Application Publication
(10) Pub. No.: US 2024/0088482 A1
(43) Pub. Date: Mar. 14, 2024

(54) THERMAL MANAGEMENT COOLING SYSTEM AND CONTROL SYSTEM FOR LITHIUM-ION BATTERY STORAGE

(71) Applicant: STEWART & STEVENSON LLC, Houston, TX (US)

(72) Inventors: Don KOBS, Houston, TX (US); James RITTER, Houston, TX (US); Mark PAYNE, Houston, TX (US); Gabriel GUTIERREZ, Houston, TX (US)

(21) Appl. No.: 18/242,882

(22) Filed: Sep. 6, 2023

Related U.S. Application Data
(60) Provisional application No. 63/405,267, filed on Sep. 9, 2022.

(51) Int. Cl. H01M 10/6567; H01M 10/48; H01M 10/613; H01M 10/63; H01M 10/651

(52) U.S. Cl. CPC H01M 10/6567; H01M 10/486; H01M 10/613; H01M 10/63; H01M 10/651

(57) ABSTRACT

A battery system includes a battery cooling system, the battery cooling system including a battery chiller, battery pods in fluid connection with the battery chiller, and at least one chiller pump, the at least one chiller pump in fluid communication with the battery chiller and the battery pods. The battery system also includes a heat exchanger, the heat exchanger in fluid communication with the battery cooling system and an inverter loop. In addition the battery system includes the inverter loop including active front end rectifiers (AFE) and LCL filters (LCL), an inverter pump in communication with the AFE and the LCL, and a temperature sensing control valve adapted to stop or start flow of an inverter loop cooling fluid from reaching the heat exchanger. Further, the battery system includes a controller, the controller in electrical communication with the chiller pumps and adapted to control the temperature of a fluid coolant or control the rate of pumping of the chiller pumps, wherein the fluid coolant is adapted to be cooled by the chiller and pass through the battery pods.

### CROSS-REFERENCE TO RELATED APPLICATIONS

This application is a nonprovisional application which claims priority from U.S. provisional application No. 63/405,267, filed Sep. 9, 2022, which is incorporated by reference herein in its entirety.

### TECHNICAL FIELD/FIELD OF THE DISCLOSURE

The present disclosure relates generally to a thermal management control system for lithium-ion battery storage.

### BACKGROUND OF THE DISCLOSURE

Thermal runaway in a battery system often begins in a single cell. Thermal runaway may be characterized by primary effects including vapor combustion, over-pressurization, explosion of the cell contents, and generation of heat and/or flames. These effects may cascade from the initial cell(s) where thermal runaway originates to other adjacent cells, leading to propagation of thermal runaway throughout a battery system. Secondary effects of non-contained thermal runaway may include harm to people, environmental damage, and/or destruction of property. Cooling systems are used to control thermal runaway.

### SUMMARY

The disclosure includes a battery system. The battery system includes a battery cooling system, the battery cooling system including a battery chiller, battery pods in fluid connection with the battery chiller, and at least one chiller pump, the at least one chiller pump in fluid communication with the battery chiller and the battery pods. The battery system also includes a heat exchanger, the heat exchanger in fluid communication with the battery cooling system and an inverter loop. In addition the battery system includes the inverter loop including active front end rectifiers (AFE) and LCL filters (LCL), an inverter pump in communication with the AFE and the LCL, and a temperature sensing control valve adapted to stop or start flow of an inverter loop cooling fluid from reaching the heat exchanger. Further, the battery system includes a controller, the controller in electrical communication with the chiller pumps and adapted to control the temperature of a fluid coolant or control the rate of pumping of the chiller pumps, wherein the fluid coolant is adapted to be cooled by the chiller and pass through the battery pods.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a block diagram of a portion of a battery cooling system consistent with at least one embodiment of the present disclosure.

FIG. 2 is a block diagram of a cooling system inverter loop consistent with at least one embodiment of the present disclosure.

FIG. 3 is a flow diagram for control system logic consistent with certain embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

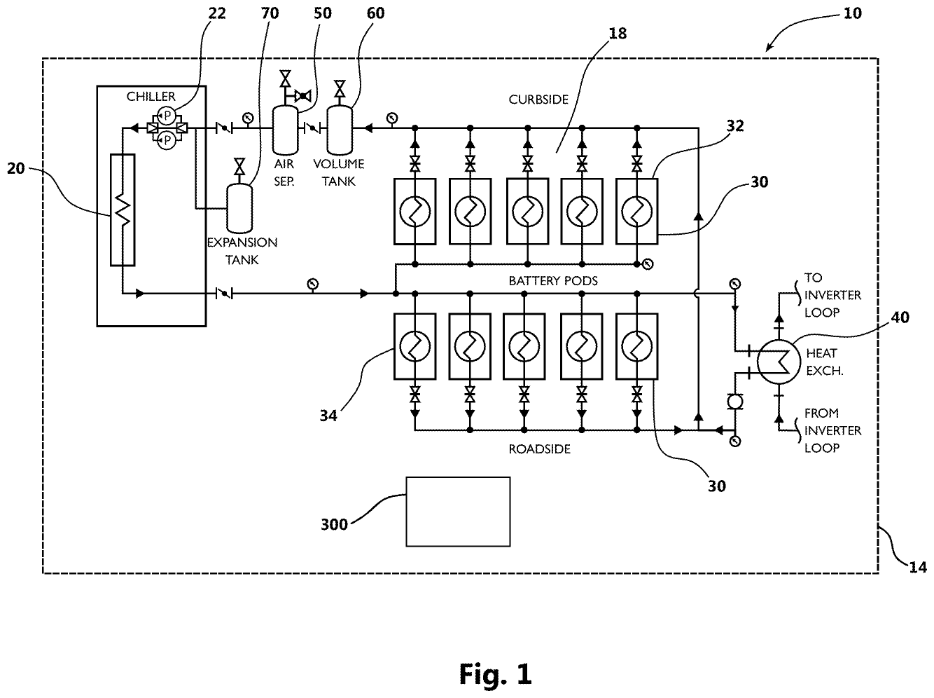

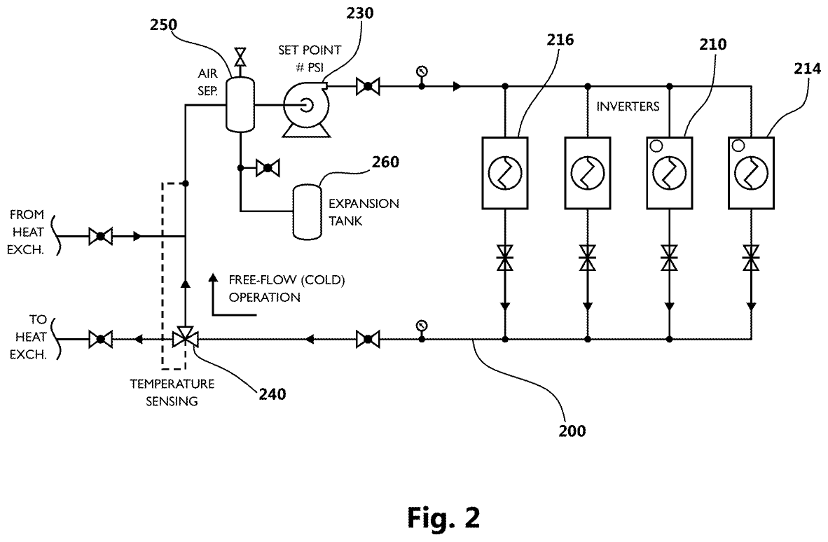

FIG. 1 is a block diagram of a portion of battery cooling system 10 consistent with at least one embodiment of the present disclosure. In certain embodiments, battery cooling system 10 includes chiller 20 and battery pods 30. Battery cooling system 10 may communicate with inverter loop 200, as shown in FIG. 2, through heat exchanger 40. A fluid coolant is circulated through chiller 20 and battery pods 30 by at least one chiller pump 22. The fluid coolant may be for example and without limitation, water, propylene glycol, ethylene glycol, a dielectric fluid, or a combination thereof. Although shown as having two chiller pumps 22 in FIG. 1, any number of chiller pumps 22 may be used.

In chiller 20, heat in the fluid coolant is exchanged with a chiller cooling fluid. The chiller cooling fluid is most often glycol although other chiller cooling fluids such as water may be used. The cooled fluid coolant that exits chiller 20 is then circulated to battery pods 30. Battery pods 30 generate heat from charging or discharging. As described above in the Background Section, overheated battery pods are problematic and cooling battery pods 30 leads to better performance and can avoid or reduce catastrophic thermal runaway.

As one of ordinary skill in the art would recognize with the benefit of this disclosure, battery pods 30 may be arranged in a variety of configurations. In mobile battery structures such as shown in FIG. 1, battery pods may be arranged in two rows, curbside battery pods 32 and roadside battery pods 34. Each of the battery pods in curbside battery pods 32 and roadside battery pods 34 are arranged in series, with rows of curbside battery pods 32 and roadside battery pods 34 also arranged in series. Fluid coolant in battery pods 30 is returned to chiller pumps 22, where it is cooled within chiller 20.

In certain embodiments, fluid coolant management devices may be used in battery cooling system 10, such as air separator tank 50, where entrained air within the fluid coolant may be expelled, volume tank 60, where a reservoir of fluid coolant is kept, and expansion tank 70, where expansion of fluid coolant due to temperature rise with battery cooling system 10 is addressed. As one of ordinary skill in the art with the benefit of this disclosure will recognize, various check valves, isolator valves, pressure and temperature sensors, and discharge valves may be used in battery cooling system 10.

Heat exchanger 40, when in operation, may use a portion of the fluid coolant to absorb heat from an inverter loop cooling fluid.

With attention to FIG. 2, an embodiment of inverter loop 200 is shown. Inverter loop 200 may use inverter loop cooling fluid to cool inverters 210. Examples of inverters 210 may include active front end rectifiers (AFE) 216 and LCL filters (LCL) 214. Inverter loop 200 may include inverter pumps 230 for circulation of inverter loop cooling fluid through inverters 210.

Inverter loop 200 may also include temperature sensing control valve 240. In certain circumstances, such as when the batteries of battery pods 30 are not charging or discharging, the inverter components, such as AFE 216 and LCL 214 may not heat. In such cases, temperature sensing control valve 240 may close based on measurement of a low set point temperature and stop the flow of inverter loop cooling fluid from entering heat exchanger 40. When the inverter loop cooling fluid temperature rises above the low set point temperature, temperature sensing control valve 240 may open and allow inverter loop cooling fluid to be cooled in heat exchanger 40.

Inverter loop 200 may include other vessels, such as inverter loop air separator 250 and expansion tank 260.

Controller 300 controls the rate of cooling of battery pods 30 by controlling the temperature of the fluid coolant or by increasing the pump rate of the chiller pumps 22. As rate of battery power is correlated to battery pod temperature, the higher the rate of battery power, the lower the temperature of the fluid coolant of the pump rate of chiller pumps 22.

Often, battery cooling system 10 is within an enclosure 14. Enclosure 14 has an enclosure temperature and enclosure humidity resulting in an enclosure dew point. When fluid coolant cools to enclosure dew point or lower, water may condense on the outside of the battery cooling system 10 components. Electronics associated with battery cooling system 10 components, including controller 300, may be damaged by such condensate. In such cases, controller 300 may change the set point of fluid coolant temperature to above the dew point. In one such embodiment, a safety margin, such as a temperature between 1 and 10° C. may be chosen such that fluid coolant temperature remains at least the safety margin above the dew point temperature of the enclosure. In these embodiments, the controller adjusts the fluid coolant temperature to the working temperature of the battery cooling system, such as 50° C. or the dew point temperature (plus the safety margin), whichever is greater. Dew point temperature plus the safety margin may be calculated by the controller according to the following algorithm:

$$Dew Point Temperature = Environmental Temperature - ( 14.55 + 0.114 * Environmental Temperature ) * ( 1 - ( \text{.01} * Relative Humidity ) ) - {( ( 2.5 + 0.007 * Environmental Temperature ) * ( 1 - ( \text{.01} * Relative Humidity ) ) )}^{3} - ( 15.9 + 0.117 * Relative Humidity ) * {( 1 - ( 0.01 * Relative Humidity ) )}^{14} + Safety Margin$$

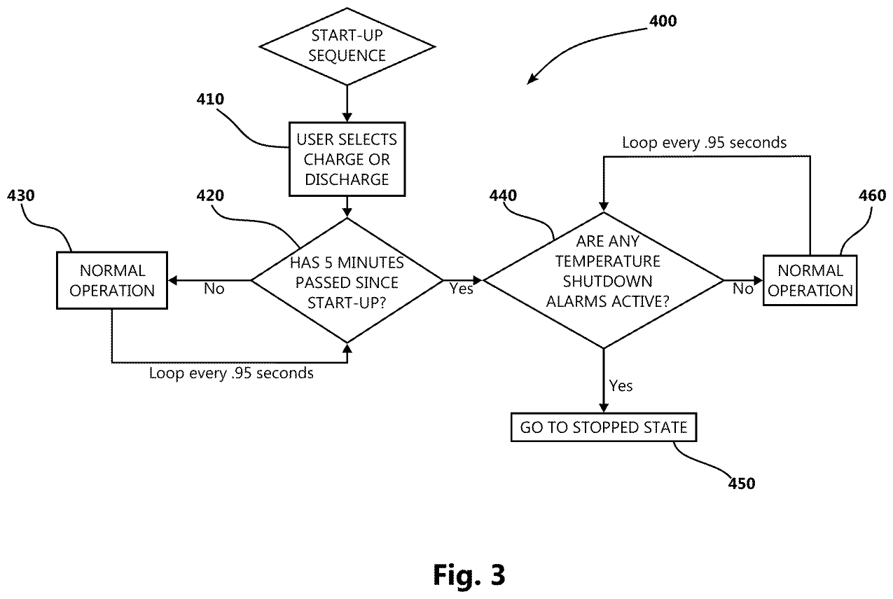

During startup of battery system 18, it may be desirable for controller 300 to override temperature shutdown alarms, as the temperature of battery cooling system 10 has not yet reached steady state. The startup period may range in some embodiments from 1 to 10 minutes. In the embodiment shown in FIG. 3 depicting logic for start-up sequence 400, the startup period is 5 minutes. In start-up sequence 400, the user selects charge or discharge for battery system 18 (410). Controller 300 determines if the shutdown period has been met (420). If the shutdown period has not been met, battery system 18 continues to operate normally (430). This check is made by controller 300 at a first pre-determined check period, shown in FIG. 3 as 0.95 seconds, although the first pre-determined check period could range for about 0.5 seconds to about 5 seconds. If the shutdown period has been met, controller 300 determines if any temperature shutdown alarms are active (440). If yes, the controller places battery system 18 in a stopped state (450). If no, battery system continues to operate normally (460). This check is made by the controller at a second pre-determined check period, shown in FIG. 3 as 0.95 seconds, although the second pre-determined check period could be from about 0.5 to about 5 seconds. The first and second pre-determined check periods may be the same or different.

In certain embodiments, battery system 18, enclosure 14, battery cooling system 10 and inverter loop 200 may be mobile, such as placed on a trailer. In some embodiments, the trailer may be a gooseneck trailer. In yet other embodiments, portions of battery system 18, enclosure 14, and battery cooling system 10 may be physically separated from inverter loop 200, such as wherein chiller 20 may be on a remote portable skid or trailer.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A battery system comprising:
a battery cooling system, the battery cooling system including:
a battery chiller;
battery pods in fluid connection with the battery chiller;
at least one chiller pump, the at least one chiller pump in fluid communication with the battery chiller and the battery pods;
a heat exchanger, the heat exchanger in fluid communication with the battery cooling system and an inverter loop;
the inverter loop including:
active front end rectifiers (AFE) and LCL filters (LCL);
an inverter pump in communication with the AFE and the LCL;
a temperature sensing control valve adapted to stop or start flow of an inverter loop cooling fluid from reaching the heat exchanger; and
a controller, the controller in electrical communication with the chiller pumps and adapted to control the temperature of a fluid coolant or control the rate of pumping of the chiller pumps, wherein the fluid coolant is adapted to be cooled by the chiller and pass through the battery pods.

2. The battery system of claim 1, wherein the battery pods are arranged in series.

3. The battery system of claim 1, wherein the chiller is adapted to exchange heat between the fluid coolant and a chiller cooling fluid.

4. The battery system of claim 1, wherein the battery pods are arranged in rows.

5. The battery system of claim 1, wherein the battery cooling system further comprises an air separator tank, a volume tank, an expansion tank, or a combination thereof in fluidic connection with the one or more chiller pump.

6. The battery system of claim 1, wherein the temperature sensing control valve is adapted to measure a temperature of an inverter loop cooling fluid temperature and close when the temperature of the inverter loop cooling fluid temperature is below a low set point temperature of the inverter loop cooling fluid.

7. The battery system of claim 6, wherein the temperature sensing control valve is adapted to open when the temperature of the invertor loop cooling fluid temperature is above the low set point temperature of the inverter loop cooling fluid.

8. That battery system of claim 6, wherein the inverter loop includes an inverter loop separator, an expansion tank, or both in fluid communication with the inverter pump.

9. The battery system of claim 1, wherein the battery system includes an enclosure in which the battery cooling system, the inverter loop, the heat exchanger, and the controller are enclosed.

10. The battery system of claim 9, wherein the enclosure has a dew point temperature.

11. The battery system of claim 10, wherein the controller is adapted to set the fluid coolant temperature at a working temperature or a dew point plus a safety margin, whichever is greater.

12. The battery system of claim 11, wherein the safety margin is between 1 and 10° C.

13. The battery system of claim 12, wherein the dew point plus the safety margin is calculated by the formula:
$$Dew Point Temperature = Environmental Temperature - ( 14.55 + 0.114 * Environmental Temperature ) * ( 1 - ( \text{.01} * Relative Humidity ) ) - {( ( 2.5 + 0.007 * Environmental Temperature ) * ( 1 - ( \text{.01} * Relative Humidity ) ) )}^{3} - ( 15.9 + 0.117 * Relative Humidity ) * {( 1 - ( 0.01 * Relative Humidity ) )}^{14} + Safety Margin$$

14. The battery system of claim 1, wherein the controller is adapted to override temperature shut down alarms during a startup period.

15. The battery system of claim 14, wherein the startup period may be from 1 to 10 minutes.

16. The battery system of claim 14, wherein if the startup period has not ended, the battery system is adapted to not shut down for the temperature shutdown alarm.

17. The battery system of claim 16, wherein if the startup period has ended, the battery system is adapted to shutdown in an event of the temperature shutdown alarm.
